(19) United States
(12) Patent Application Publication
(10) Pub. No.: US 2012/0170316 A1
(43) Pub. Date: Jul. 5, 2012

(54) LIGHT GUIDE PANEL AND FABRICATING METHOD THEREOF

(75) Inventors: Guo-Chen Lee, Taoyuan (TW); Shin-Kun Lee, Taoyuan (TW); Chia-Chen Lee, Taoyuan (TW); I-Ping Huang, Taoyuan (TW); Tsung-Yung Hung, Taoyuan (TW)

(73) Assignee: GLOBAL LIGHTING TECHNOLOGIES INC., Taoyuan (TW)

(21) Appl. No.: 13/335,982

(22) Filed: Dec. 23, 2011

(30) Foreign Application Priority Data
Dec. 31, 2010 (TW) 99147318
Dec. 31, 2010 (TW) 99147319

(51) Int. Cl. F21V 8/00; B26D 3/06

(52) U.S. Cl. 362/617; 83/875; 362/615

(57) ABSTRACT

A light guide panel (LGP) having a surface which has a first direction and a second direction vertical with each other is provided. The LGP includes an optical element array and a rubbing portion. The optical element array is disposed on the surface of the LGP and extended in the first direction. The rubbing portion is disposed on the surface of the LGP and extended in the second direction. Moreover, a fabricating method of the LGP by utilizing a cutting tool is also provided.

### CROSS-REFERENCE TO RELATED APPLICATION

This application claims the priority benefit of Taiwan application serial no. 99147318, filed on Dec. 31, 2010. This application also claims the priority benefit of a Taiwan application serial no. 99147319, filed on Dec. 31, 2010. The entirety of each of the above-mentioned patent applications is hereby incorporated by reference herein and made a part of this specification.

### BACKGROUND OF THE APPLICATION

1. Field of the Application

The present invention relates to a light guide panel and a method of fabricating the same. In particular, the present invention relates to a light guide panel having an optical element array, and a fabricating method of the light guide panel by utilizing a cutting tool to form the optical element array on the light guide panel.

2. Description of Related Art

In the precision processing, cutting tools are commonly used to cut various light guide panels to form optical microstructures. Taking the surface treatment of the light guide panel as an example, when the optical microstructures are to be manufactured on the light guide panel, a single cutting tool can be used to form grooves on the light guide panel surface by means of forwardly and backwardly cutting. However, it would have the following drawbacks:

First, the tool life of the cutting tool may be shortened. In the grooves cutting process, since the cutting tool is continuously and directly rubbed against the light guide panel, the cutting tool is easy to be worn and broken, deform, and reduce in hardness due to high temperature. In addition, the precision of the groove processed by the worn cutting tool would reduce and it may lead to the process yield of the light guide panel cannot be increased.

Moreover, the cutting speed of the above mentioned method is rather slow. Since each groove is formed by means of the single cutting tool forwardly and backwardly cutting, if the number of grooves or the area to be cut is quite huge, the whole process time would be very long. In one aspect, the way of shortening the single cutting path of the cutting tool can be tried to increase the cutting speed. However, it may lead to the reducing of the tool life of the cutting tool due to the high temperature generated during a very short time by the high cutting speed.

In addition, the cutting tool mentioned above is not suitable to be used in processing the microstructures in special shapes and mass production. When the grooves in special shapes are required to be fabricated, it is necessary to use different kind of cutting tool. More specifically, a first kind of cutting tool is necessary to use in cutting a first kind of groove having a first kind of microstructures, while a second kind of cutting tool is necessary to use in cutting a second kind of groove having a second kind of microstructures. Accordingly, the cutting path of the cutting tool and the cutting tool changing sequence would become rather complicated, and it may lead to the difficulty in mass production of the light guide panels. In light of the above mentioned, in precision processing, it is necessary to develop the cutting tool capable to solve the present problem.

Especially, using the single cutting tool in processing the microstructures of the light guide panel may result the lower precision of the microstructures. In light of the above mentioned, in precision processing, it is necessary to develop the fabricating method of the light guide panel capable to solve the present problem.

### SUMMARY OF THE INVENTION

Accordingly, the present invention provides a light guide panel having an optical element array and further has rubbing portions which can increase the optical effect of the light guide panel.

The present invention provides a fabricating method of a light guide panel by using a novel cutting tool and capable to fabricate the above mentioned light guide panel.

The present invention provides a cutting tool, capable of cutting process or surface treatment, and further capable of fabricating microstructures on the surface of the workpiece.

The present invention provides a cutting tool module having a plurality of above mentioned cutting tools.

The present invention provides a fabricating method of a cutting tool capable to fabricate above mentioned cutting tools.

The present invention provides a light guide panel having a surface which has a first direction and a second direction and an included angle is formed between the first direction and the second direction. The light guide panel includes an optical element array and a rubbing portion. The optical element array is disposed on the surface of the light guide panel and extended in the first direction. The rubbing portion is disposed on the surface of the light guide panel and extended in the second direction.

The invention further provides a fabricating method of a light guide panel. First, at least a light guide panel is provided. The light guide panel has a surface which has a first direction and a second direction and an included angle is formed between the first direction and the second direction. Then, at least a cutting tool is provided, wherein each cutting tool includes a base, at least a cutting section and a plurality of microstructures. The base has a rotating axis. The cutting section is disposed on the base, and arranged along an extending direction of the rotating axis. The microstructures are disposed on the cutting section. After that, the cutting tool is rotated and the light guide panel is cut, wherein after being cut the light guide panel includes an optical element array and a rubbing portion. The optical element array is disposed on the surface of the light guide panel and extended in the first direction. The rubbing portion is disposed on the surface of the light guide panel and extended in the second direction.

According to an embodiment of the present invention, the rubbing portion is distributed on a same horizontal/vertical base line of the surface, or on different horizontal/vertical base lines of the surface.

According to an embodiment of the present invention, the included angle is 90±10 degrees.

According to an embodiment of the present invention, the surface includes a light incident surface, a light emitting surface or a reflective surface of the light guide panel.

According to an embodiment of the present invention, the optical element array includes a plurality of optical microlenses protruded from the surface of the light guide panel, and the shape of the optical microlenses is selected from a semicircular shape, a V shape, an R-shaped groove or a combination thereof.

According to an embodiment of the present invention, the optical element array includes a plurality of optical microlenses recessed from the surface of the light guide panel, and the shape of the optical microlenses is selected from a semicircular shape, a V shape, an R-shaped groove or a combination thereof.

According to an embodiment of the present invention, the optical element array includes a plurality of optical microlenses, and the optical microlenses are in the same size or in different sizes from each other.

According to an embodiment of the present invention, the cutting section is coaxially arranged along the extending direction of the rotating axis.

According to an embodiment of the present invention, the cutting section is spirally arranged along the extending direction of the rotating axis.

According to an embodiment of the present invention, the base and the cutting section are integrally formed or configured to each other.

According to an embodiment of the present invention, the microstructures are protruded from the cutting section. And the shape of the microstructures is selected from a semicircular shape, a V shape, an R-shaped groove or a combination thereof. The shape of the microstructures is complementary to the shape of the optical microlenses of the optical element array.

According to an embodiment of the present invention, the microstructures are recessed from the cutting section. And the shape of the microstructures is selected from a semicircular shape, a V shape, an R-shaped groove or a combination thereof. The shape of the microstructures is complementary to the shape of the optical microlenses of the optical element array.

According to an embodiment of the present invention, the microstructures are in the same size or in different sizes from each other.

The present invention provides a cutting tool including a base, at least a cutting section and a plurality of microstructures. The base has a rotating axis. The cutting section is disposed on the base, and arranged along an extending direction of the rotating axis. The microstructures are disposed on the cutting section.

The present invention further provides a cutting tool module having a plurality of above mentioned cutting tools and arranged along the extending direction of the rotating axis.

The present invention further provides a fabricating method of the cutting tool including the following steps: a base having a rotating axis is provided. At least a cutting section disposed on the base and arranged along an extending direction of the rotating axis is provided. A plurality of microstructures disposed on the cutting section is provided.

According to an embodiment of the present invention, the cutting section is coaxially arranged along the extending direction of the rotating axis.

According to an embodiment of the present invention, the cutting section is spirally arranged along the extending direction of the rotating axis.

According to an embodiment of the present invention, the base and the cutting section are integrally formed.

According to an embodiment of the present invention, the base and the cutting section are configured to each other.

According to an embodiment of the present invention, the microstructures are protruded from the cutting section. And the shape of the microstructures is selected from a semicircular shape, a V shape, an R-shaped groove or a combination thereof.

According to an embodiment of the present invention, the microstructures are recessed from the cutting section. And the shape of the microstructures is selected from a semicircular shape, a V shape, an R-shaped groove or a combination thereof.

According to an embodiment of the present invention, the microstructures are in the same size or in different sizes from each other.

According to an embodiment of the present invention, the cutting section is continuously or discontinuously disposed on the base.

According to an embodiment of the present invention, the cutting section is discontinuously disposed on the base, and the cutting sections are coaxially assembled on the base.

According to an embodiment of the present invention, the cutting section is discontinuously disposed on the base, and the cutting sections are assembled in different axially on the base.

In light of the above, the light guide panel of the present invention has an optical element array and rubbing portion, wherein the rubbing portion can provide an optical effect of atomizing the light beam. By utilizing the cutting tool of the present invention in processing the light guide panel or surface treatment, the optical element array and the rubbing portion can be easily formed on the surface of the light guide panel. Especially, the fabricating method of the light guide panel is adapted to form the optical element array and the rubbing portion on the very thin light guide panel. In addition, the cutting section of the cutting tool of the present invention is arranged along the extending direction of the rotating axis of the base, and the microstructures are formed on the cutting section. Accordingly, the processing efficiency of the cutting tool can be increased when the cutting tool is used in processing the workpiece or surface treatment. Furthermore, any required microstructures can be formed on the workpiece by forming various microstructures on the cutting section.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective schematic view of a light guide panel of the embodiment of the present invention, and a schematic view of the optical microstructures of the surface of the light guide panel.

FIG. 2 is a flowchart illustrating a fabricating method of the light guide panel according to one embodiment of the present invention.

FIG. 3 is a schematic view of a cutting tool of the embodiment of the present invention.

FIG. 4 is a schematic view of another cutting tool of the embodiment of the present invention.

FIG. 5 is a schematic view of another cutting tool of the embodiment of the present invention.

FIG. 6 is a schematic view of the microstructures of the cutting tool according to one embodiment of the present invention.

FIG. 7 is a schematic view of the microstructures of the cutting tool according to another embodiment of the present invention.

FIG. 8 is a schematic view of the cutting process of the light guide panel with the cutting tool of the embodiment of the present invention.

FIG. 9 is a schematic view of the surface treatment of the light guide panel with the cutting tool of the embodiment of the present invention.

FIG. 10 is a schematic view of a cutting tool module of the embodiment of the present invention.

FIG. 11A is a schematic view of another cutting tool of the embodiment of the present invention.

FIG. 11B is a schematic view of another cutting tool of the embodiment of the present invention.

FIG. 12 is a flowchart illustrating a fabricating method of the cutting tool of the embodiment of the present invention.

### DESCRIPTION OF EMBODIMENTS

### Light Guide Panel

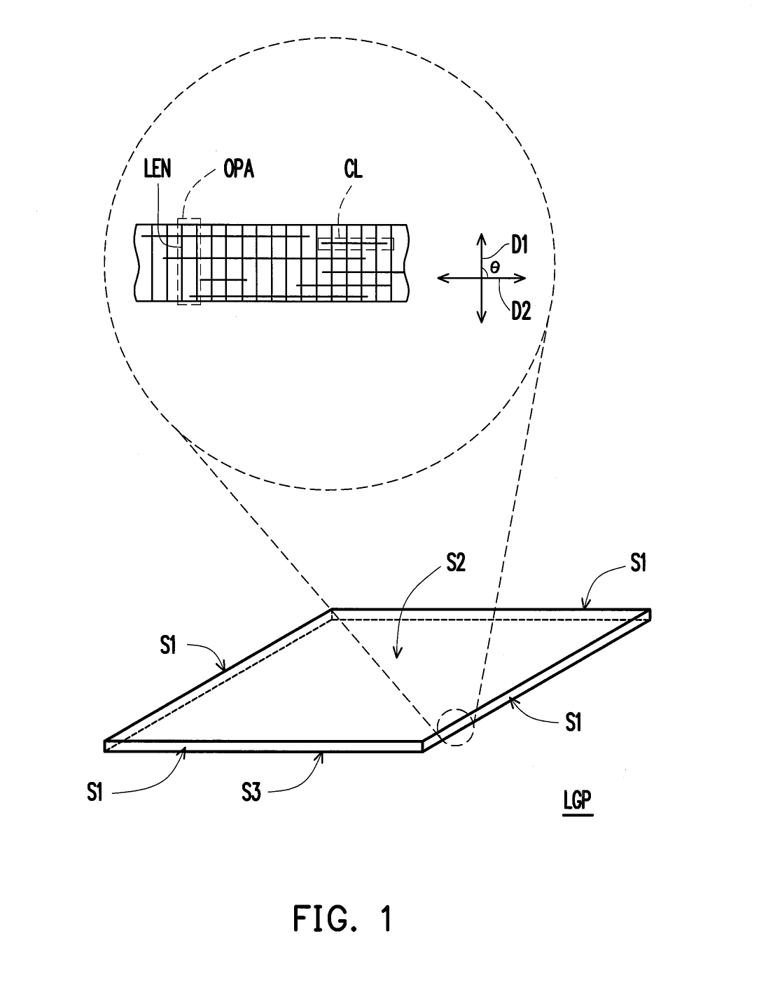

FIG. 1 is a perspective schematic view of a light guide panel according to one embodiment of the present invention, and a schematic view of the optical microstructures disposed on the surface of the light guide panel. Referring to FIG. 1, the light guide panel LGP has a surface S1 (S2 or S3) which has a first direction D1 and a second direction D2 and an included angle θ is formed between the first direction D1 and the second direction D2. In one embodiment, the surface S1 of the light guide panel LGP can be a light incident surface, the surface S2 of the light guide panel LGP can be a light emitting surface, and the surface S3 of the light guide panel LGP can be a reflective surface. The included angle θ can be 90±10 degrees, preferably 90 degrees.

The optical microstructures of the light guide panel LGP may includes an optical element array OPA and a rubbing portion CL. The optical element array OPA can be disposed on the surface S1, S2, S3 of the light guide panel LGP and extended in the first direction D1.

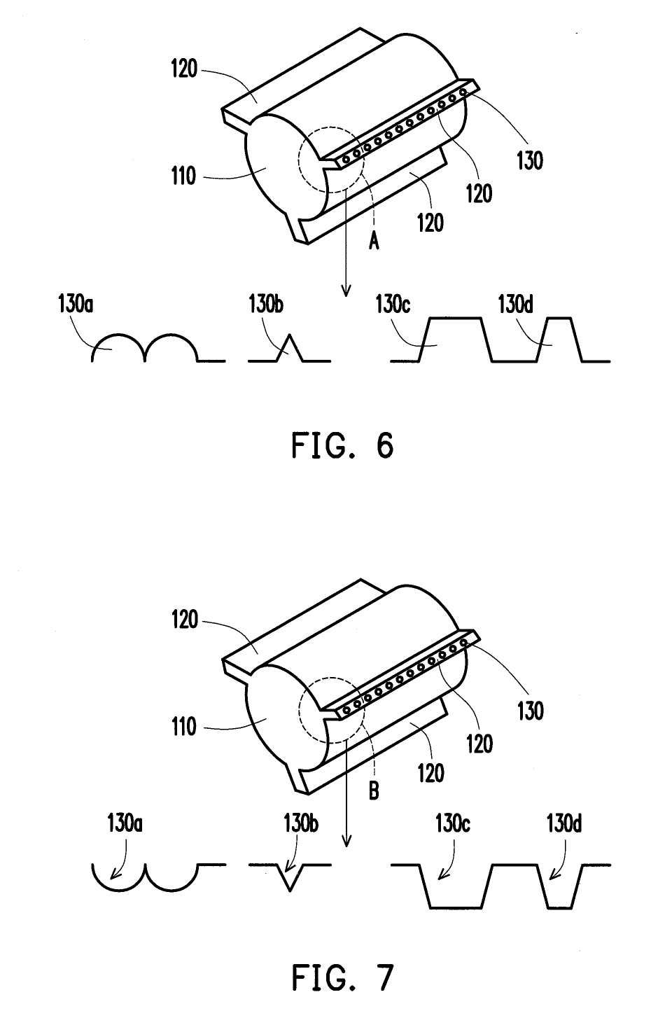

More specifically, the optical element array OPA may includes a plurality of optical microlenses LEN recessed from the surface S1 of the light guide panel LGP, and the shape of the optical microlenses LEN is selected from a semicircular shape, a V shape, an R-shaped groove or a combination thereof (being complementary to the microstructures 130 protruded from the cutting section 120 illustrated in FIG. 6).

In addition, in another embodiment, the optical element array OPA may also include a plurality of optical microlenses LEN protruded from the surface S1 of the light guide panel LGP, and the shape of the optical microlenses LEN is selected from a semicircular shape, a V shape, an R-shaped groove or a combination thereof (being complementary to the microstructures 130 recessed from the cutting section 120 illustrated in FIG. 7). Moreover, the plurality of optical microlenses LEN of the optical element array OPA are in the same/different size from each other, wherein the same/different size means the same/different in area, or in volume. The optical element array OPA can be regularly or randomly disposed on the surface S1, S2, S3 of the light guide panel LGP depending on the required optical effect.

Referring to FIG. 1, the rubbing portion CL can be disposed on the surface S1, S2, S3 of the light guide panel LGP and extended in the second direction D2. Specifically, the optical element array OPA and the rubbing portion CL can be formed on the at least one surface S1, S2 or S3 or all the surfaces S1, S2, S3 of the light guide panel LGP.

Furthermore, the rubbing portion CL can be randomly distributed on the surface S1, S2, S3 of the light guide panel LGP, i.e., the rubbing portion CL is distributed on a same horizontal/vertical base line (not shown) of the surface S1, or on different horizontal/vertical base lines of the surface S1. In more detail, the surface S1 can have a plurality of horizontal base lines, and rotating the horizontal base lines into 90 degrees can form a plurality of vertical base lines. The rubbing portion CL can be located on the same horizontal base line (regularly disposed), or located on different horizontal base lines (randomly disposed) so as to form an optical effect of a mist surface through the arrangement of the rubbing portion CL.

A fabricating method of the light guide panel of the present invention is explained hereinafter.

### Fabricating Method of the Light Guide Panel

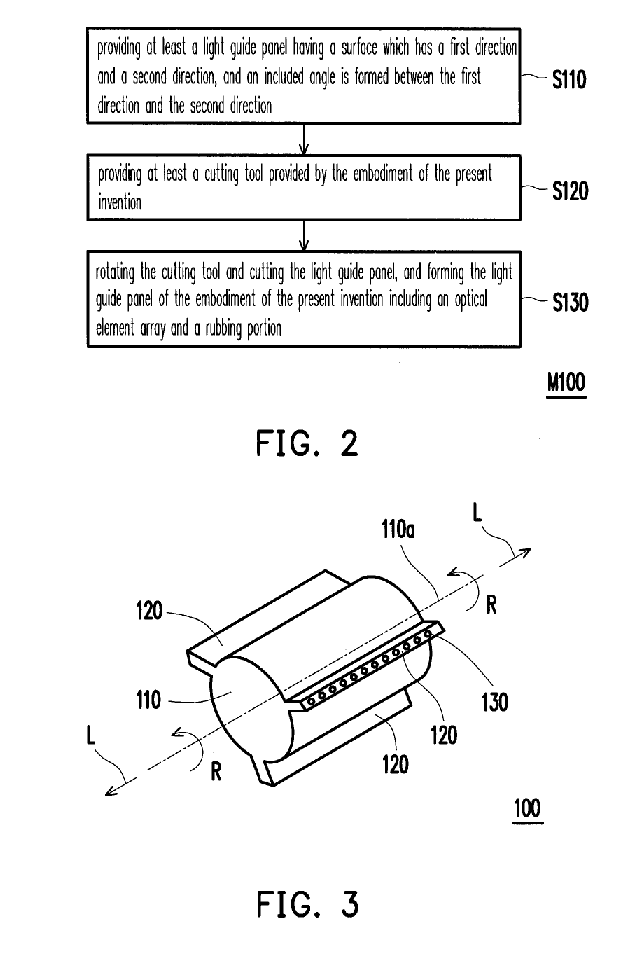

FIG. 2 is a flowchart illustrating a fabricating method of the light guide panel of the embodiment of the present invention. FIG. 3 is a schematic view of a cutting tool of the embodiment of the present invention. Please refer to FIGS. 1-3 to understand the fabricating method M100 of the light guide panel of the present invention. It can be seen in FIG. 2, the fabricating method M100 includes the steps S110-S130.

First, in step S110, at least a light guide panel LGP as shown in FIG. 1 is provided. The light guide panel LGP has a surface S1, S2, S3 which has a first direction D1 and a second direction D2 and an included angle θ is formed between the first direction D1 and the second direction D2.

Then, in step S120, at least a cutting tool 100 as shown in FIG. 3 is provided, wherein each cutting tool 100 includes a base 110, at least a cutting section 120 and a plurality of microstructures 130. The base 110 has a rotating axis 110a. The cutting section 120 is disposed on the base 110, and arranged along an extending direction L of the rotating axis 110a. The microstructures 130 are disposed on the cutting section 120. The number, the length and the location arranged on the base 110 of the cutting section 120 can be changed according to the desired optical effect of the light guide panel LGP.

After that, in step S130, the cutting tool 100 is rotated and the light guide panel LGP is cut, wherein after being cut the light guide panel LGP as shown in FIG. 1 includes an optical element array OPA and a rubbing portion CL. The optical element array OPA can be disposed on the surface S1, S2, S3 of the light guide panel LGP and extended in the first direction D1. The rubbing portion CL is disposed on the surface S1, S2, S3 of the light guide panel LGP and extended in the second direction D2.

It has to be noted that the optical element array OPA and the rubbing portion CL can be formed on the at least one surface S1, S2 or S3 or all the surfaces S1, S2, S3 of the light guide panel LGP by using the cutting tool 100.

It should be noted that three cutting sections 120 are illustrated in FIG. 3, yet the number of the cutting sections 120 can be changed according to the user's requirement, and it is not limited to be three. In addition, the microstructures 130 with the same or different shapes can be respectively disposed on each of the cutting sections 120 so as to fabricate a cutting tool 100 having a combination of microstructures with particular shapes.

The microstructures 130 can be disposed on the cutting section 120 so that the microstructures 130 can rotate along the tangent of the rotating direction R of the cutting tool 100 in order to cut or rub the light guide panel LGP which is in contact with the microstructures 130 when the cutting tool 100 is rotating in high speed. As a result, the optical element array OPA and the rubbing portion CL can be naturally formed on the cutting surface of the light guide panel LGP, at the same time when the light guide panel LGP is cut. Besides, the shape of the optical microlenses LEN of the optical element array OPA and the shape of the microstructures 130 of the cutting tool 100 are complementary to each other.

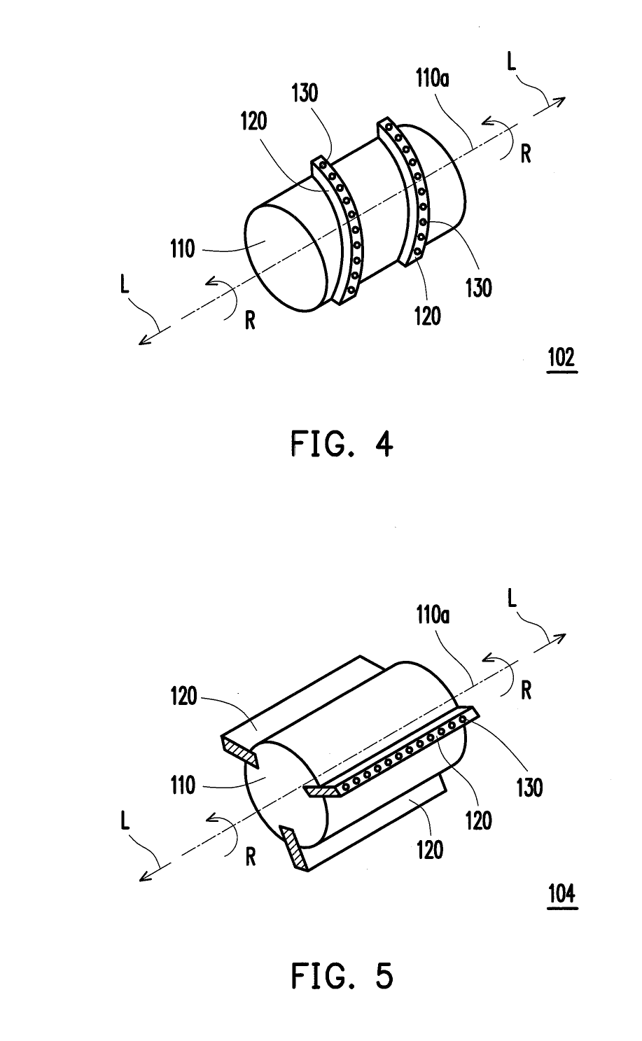

Referring to FIG. 3, the cutting section 120 can be disposed on the base 110, and coaxially arranged along the extending direction L of the rotating axis 110a. However, in other embodiments, the cutting section 120 can be in different arrangements. FIG. 4 is a schematic view of another cutting tool of the embodiment of the present invention. Referring to FIG. 4, the same components of the cutting tool 102 and the cutting tool 100 of FIG. 3 are given the same numbering. It has to be noted that in the embodiment, the cutting section 120 is spirally arranged along the extending direction L of the rotating axis 110a. Through the coaxially arrangement or the spirally arrangement, the microstructures 130 located in various locations of the cutting section 120 can proceed to the cutting process or the surface rubbing effect so that the cutting tool 100 is appropriate to be used in cutting or surface treatment of the workpiece having a large area. Thus, the tool wear problem due to the repeatedly cutting with the single cutting tool in the prior art can be solved.

Referring to FIG. 3, the base 110 and the cutting section 120 are integrally formed. That is, the cutting section 120 is directly formed on a cylindrical workpiece (not shown) by using precision machining process or electrical discharge machining (EDM) process so that the cutting section 120 and the base 110 are integrally formed.

However, in other embodiments, the base 110 and the cutting section 120 can be in different arrangements. FIG. 5 is a schematic view of another cutting tool of the embodiment of the present invention. Referring to FIG. 5, the same components of the cutting tool 104 and the cutting tool 100 of FIG. 3 are given the same numbering. It can be seen that the base 110 and the cutting section 120 are assembled with each other. In more detail, the base 110 and the cutting section 120 are separately fabricated. And method of adhering or particular latching structure can be used to fix the cutting section 120 onto the base 110 so that the cutting section 120 will not separate from the base 110 when the cutting tool 104 is rotating in high speed.

FIG. 6 is a schematic view of the microstructures of the cutting tool of the embodiment of the present invention. Referring to FIG. 6, the microstructures 130 can be clearly seen after the region A of the cutting section 120 is enlarged. In the embodiment, the microstructures 130 can be protruded from the cutting section 120. The shape of the microstructures 130 can be selected from a semicircular shape, a V shape, an R-shaped groove or a combination thereof, that is, as shown in FIG. 6, the semicircular shape 130a, the V shape 130b, the R-shaped groove 130c, 130d. By using the protruded microstructures 130 from the cutting section 120 as shown in FIG. 6, the optical microlenses LEN recessed from the surface S1 of the light guide panel LGP can be formed on the surface S1 of the light guide panel LGP.

FIG. 7 is a schematic view of the microstructures of the cutting tool according to another embodiment of the present invention. Referring to FIG. 7, the microstructures 130 recessed from the cutting section 120 can be clearly seen after the region B of the cutting section 120 is enlarged. The shape of the microstructures 130 can be selected from a semicircular shape, a V shape, an R-shaped groove or a combination thereof, that is, as shown in FIG. 7, the semicircular shape 130a, the V shape 130b, the R-shaped groove 130c, 130d. By using the recessed microstructures 130 from the cutting section 120 as shown in FIG. 7, the optical microlenses LEN protruded from the surface S1 of the light guide panel LGP can be formed on the surface S1 of the light guide panel LGP.

The microstructures 130a-130d can be in the same size or in different sizes from each other. For example, the R-shaped grooves microstructures 130c, 130d with different sizes or the semicircular shape microstructures 130a with the same size can be used. Based on actual design demands, people having ordinary skill in the art can modify the type and size of the microstructures 130a-130d. Hence, the various microstructures 130 can be combined directly on the cutting section 120. Therefore, the problem that the cutting path of the cutting tool is necessary to be changed and the cutting tool changing sequence would become rather complicated can be solved.

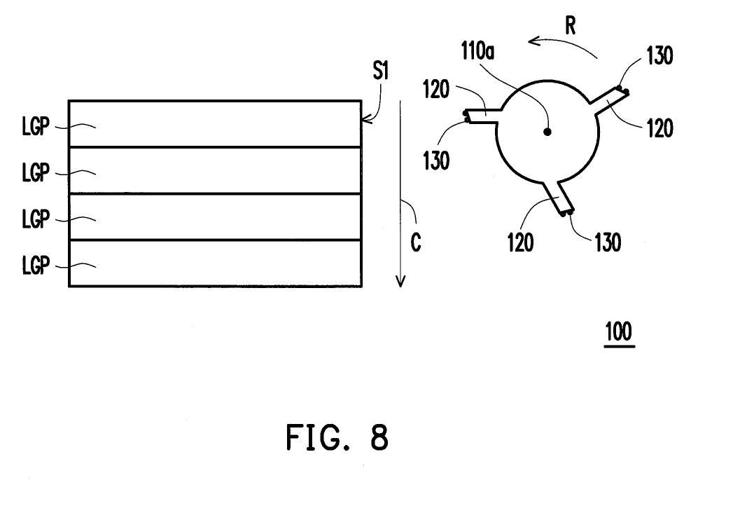

FIG. 8 is a schematic view of the cutting process of the light guide panel with the cutting tool of the embodiment of the present invention. Referring to FIG. 8, the cutting tool 100 can rotate in high speed in the rotating direction R so as to cut the single light guide panel LGP or the plurality of light guide panels LGP stacked in the cutting direction C. It has to be noted that since the microstructure 130 is disposed on the cutting section 120 of the cutting tool 100, at the same time the light guide panel LGP is cut, as shown in FIG. 1, an optical element array OPA and a rubbing portion CL can be formed on the surface S1 (light incident surface) of the light guide panel LGP.

Accordingly, high speed cutting of the stacked light guide panels LGP can be done by using the cutting tool 100. It can not only reduce the cutting time of the light guide panel LGP, the optical element array OPA and the rubbing portion CL can also be formed on the surface S1 (light incident surface) of the light guide panel LGP. Especially, as for the very thin light guide panel LGP, the optical element array OPA can easily be formed on the surface S1 (light incident surface) of the light guide panel LGP by using the cutting tool 100.

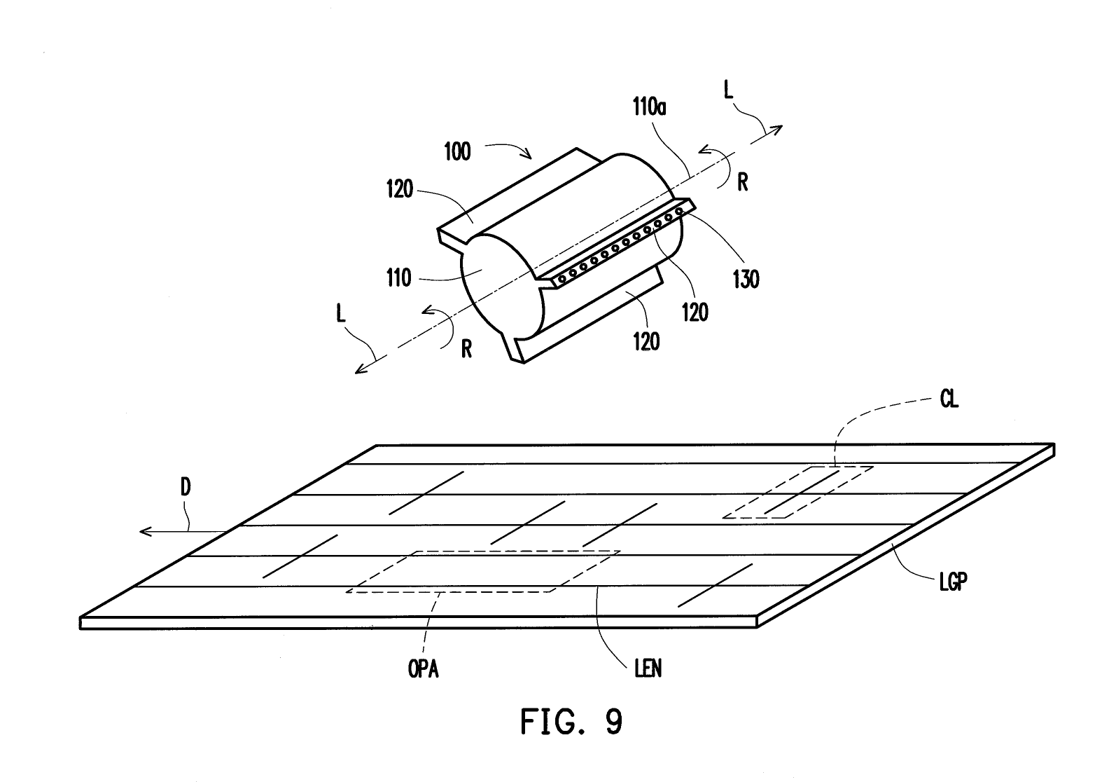

FIG. 9 is a schematic view of the surface treatment of the light guide panel with the cutting tool of the embodiment of the present invention. Referring to FIG. 9, the cutting tool 100 can rotate in high speed. The light guide panel LGP can be transmitted along the transmission direction D on the conveyor belt (not shown). The microstructures 130 on the cutting section 120 can be in contact with the surface S2 (light emitting surface) or S3 (reflective surface) of the light guide panel LGP. The optical element array OPA and the rubbing portion CL are processed. The formed optical element array OPA is, for example, a lens array capable of providing the optical effect. And rubbing portion CL can be used to mist the light beam.

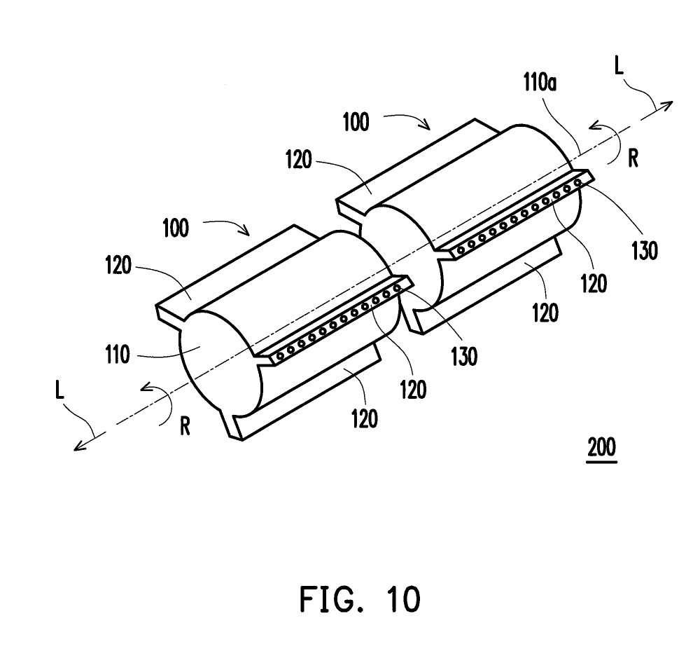

FIG. 10 is a schematic view of a cutting tool module of the embodiment of the present invention. Referring to FIG. 10, the cutting tool module 200 includes a plurality of above mentioned cutting tools 100 and arranged along the extending direction L of the rotating axis 110a.

As shown in FIG. 9, merely one cutting tool 100 is used for processing the surface treatment. However, the present invention is not limited to one cutting tool 100. In detail, when the area of the light guide panel LGP is increased, the cutting tool module 200 including a plurality of cutting tools 100 can easily proceed to the cutting process or the surface treatment of the light guide panel LGP with a large area.

Additionally, the cutting tool module 200 corresponding to the light guide panel LGP with a particular size can be assembled for proceeding the cutting process or surface treatment to the light guide panel LGP with a particular size. Moreover, when any one cutting tool 100 of the cutting tool module 200 is broken, the broken cutting tool 100 can be directly replaced by a new one so as to increase the maintenance efficiency.

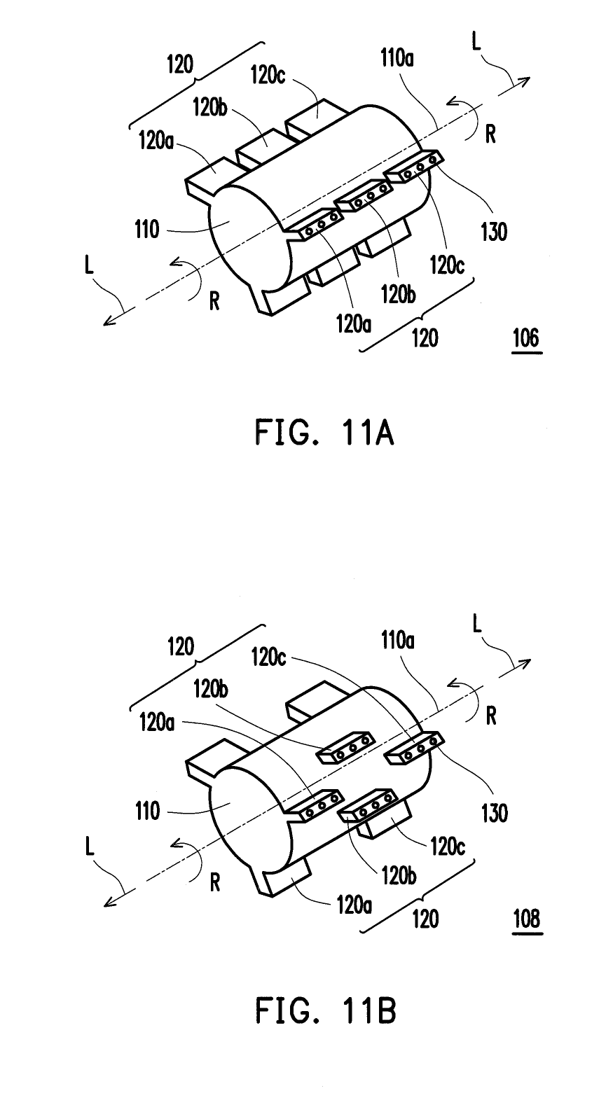

Especially, any combination of cutting tools 100-104 with various microstructures 130 can be formed the cutting tool module 200. Accordingly, various types of optical element array OPA can be fabricated. For example, the cutting section 120 can be continuously or discontinuously disposed on the base 110. FIG. 11A is a schematic view of another cutting tool of the embodiment of the present invention. Referring to FIG. 11A, the same components of the cutting tool 106 and the cutting tool 100 of FIG. 3 are given the same numbering. It can be noted that the cutting section 120 is discontinuously disposed on the base 110, and the number of cutting sections 120 is plural (120a, 120b, 120c) and they are coaxially arranged on the base 110.

Furthermore, the total length of the cutting sections 120a, 120b, 120c shown in FIG. 11A can be unequal to the length of the base 110. Additionally, the cutting sections 120a, 120b, 120c can also be assembled with each other (by using the latching structure which is not shown in the figure) so that the cutting sections 120a, 120b, 120c can form the cutting section 120 with stripe shape as shown in FIG. 3, and the total length is equal to the length of the base 110.

Certainly, the cutting section 120 of the cutting tool 102 shown in FIG. 4 also can be fabricated by using the continuously (FIG. 4) or discontinuously (FIG. 11A) disposing method to the base 110. And when the cutting section is not continuously disposed on the base, the number of the cutting section may be plural and coaxially assembled to the base.

FIG. 11B is a schematic view of another cutting tool of the embodiment of the present invention. Referring to FIG. 11B, the same components of the cutting tool 108 and the cutting tool 100 of FIG. 3 are given the same numbering. It can be noted that the cutting section 120 is discontinuously disposed on the base 110, and the number of cutting sections 120 is plural (120a, 120b, 120c) and they are arranged in different axially on the base 110.

As described above, the fabricating process of the cutting tool 106 can be more flexible by discontinuously disposing the cutting section and assembling the plurality of the cutting sections.

### Fabricating Method of the Cutting Tool

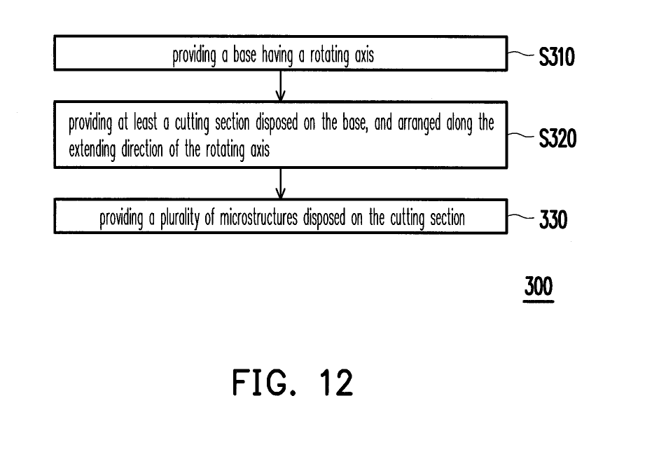

FIG. 12 is a flowchart illustrating a fabricating method of the cutting tool of the embodiment of the present invention. Referring to FIG. 12 and FIG. 3 together, the fabricating method 300 of the cutting tool includes the following steps S310-S330. First, in step S310, the base 110 having a rotating axis 110a is provided. A material of the base 110 is, for example, high hardness metal, diamond or other suitable materials. And a cylinder is preferably used as the base 110.

Then, in step S320, at least a cutting section 120 disposed on the base 110 and arranged along the extending direction L of the rotating axis 110a is provided. The cutting section 120 is processed on the base 110 by using electrical discharge machining (EDM) process or mechanical machining process. Or recess (not shown) can be formed on the base 110, and the cutting section 120 is separately fabricated and the cutting section 120 can be assembled to the recess of the base 110. The base 110 and the cutting section 120 can be integrally formed or be assembled with each other after separately fabricated. The cutting section 120 can be continuously or discontinuously disposed on the base 110. And when the cutting section 120 is continuously disposed on the base 110, and the number of cutting sections 120 can be plural, 120a, 120b, 120c and they are coaxially arranged or arranged in different axially on the base 110 (as shown in FIG. 11A and FIG. 11B).

After that, in step S330, a plurality of microstructures 130 disposed on the cutting section 120 is provided. The microstructures 130 can be previously formed on the cutting section 120, and the cutting section 120 formed with the microstructures 130 is then assembled to the base 110. Or, after integrally forming the base 110 and the cutting section 120, the microstructures 130 can be then fabricated by utilizing the electrical discharge machining process or mechanical machining process to the cutting section 120.

In the fabricating method 300 of the cutting tool, the various embodiments of the fabricated cutting tools 100-106 have been described above, and it is not repeated thereto. It has to be noted that the sequence of the steps S310-S330 can be changed in fabricating the cutting tools 100-106.

In light of the foregoing, the light guide panel of the present invention and the fabricating method thereof at least possess the following advantages:

By utilizing the cutting tool of the present invention in processing the light guide panel or surface treatment, the optical element array and the rubbing portion can be easily formed on the surface of the light guide panel, wherein the rubbing portion can provide the optical effect of misting the light beam. Furthermore, the fabricating method of the light guide panel is adapted to form the optical element array and the rubbing portion on the very thin light guide panel.

During the cutting process or the surface treatment, the microstructures disposed on the cutting section can proceed to the cutting process to the light guide panel, are capable to increase the cutting speed of the cutting tool and elongate the tool life of the cutting tool. Furthermore, any required optical element array can be formed on the light guide panel by forming various microstructures on the cutting section, and adapted to process the optical element array with particular shape.

In addition, the cutting tool, the cutting tool module and the fabricating method thereof disclosed in the present invention have at least the following advantages:

The cutting section of the cutting tool of the present invention is arranged along the extending direction of the rotating axis of the base, and the microstructures are formed on the cutting section. Accordingly, during the cutting process or the surface treatment, the microstructures disposed on the cutting section can proceed to the cutting process to the light guide panel, are capable to increase the cutting speed of the cutting tool and elongate the tool life of the cutting tool. Furthermore, any required microstructures can be formed on the workpiece by forming various microstructures on the cutting section. Additionally, the various cutting tools can be combined to form the cutting tool module and it is adapted to proceed to the cutting process or the surface treatment to the workpiece with a particular size, and easy to be replaced when the single cutting tool is broken. The fabricating method of the cutting tool is simple. At the same time during the cutting process or the surface treatment to the workpiece, the microstructures of the cutting tool can be formed on the surface of the workpiece.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A light guide panel having a surface which has a first direction and a second direction and an included angle is formed between the first direction and the second direction, comprising:
an optical element array disposed on the surface of the light guide panel and extended in the first direction; and
a rubbing portion disposed on the surface of the light guide panel and extended in the second direction.

2. The light guide panel as claimed in claim 1, wherein the rubbing portion is distributed on a same horizontal/vertical base line of the surface.

3. The light guide panel as claimed in claim 1, wherein the rubbing portion is distributed on different horizontal/vertical base lines of the surface.

4. The light guide panel as claimed in claim 1, wherein the included angle is 90±10 degrees.

5. The light guide panel as claimed in claim 1, wherein the surface comprises a light incident surface, a light emitting surface or a reflective surface of the light guide panel.

6. The light guide panel as claimed in claim 1, wherein the optical element array comprises a plurality of optical microlenses protruded from the surface of the light guide panel, and the shape of the optical microlenses is selected from a semicircular shape, a V shape, an R-shaped groove or a combination thereof.

7. The light guide panel as claimed in claim 1, wherein the optical element array comprises a plurality of optical microlenses recessed from the surface of the light guide panel, and the shape of the optical microlenses is selected from a semicircular shape, a V shape, an R-shaped groove or a combination thereof.

8. The light guide panel as claimed in claim 1, wherein the optical element array comprises a plurality of optical microlenses, and the optical microlenses are in the same size or in different sizes from each other.

9. A fabricating method of a light guide panel, the method comprising:
providing a light guide panel, the light guide panel having a surface which has a first direction and a second direction and an included angle is formed between the first direction and the second direction;
providing at least one cutting tool, comprising:
a base having a rotating axis;
at least a cutting section disposed on the base, and arranged along an extending direction of the rotating axis;
a plurality of microstructures disposed on the cutting section; and
rotating the cutting tool and cutting the light guide panel, wherein after being cut the light guide panel comprises:
an optical element array disposed on the surface of the light guide panel and extended in the first direction; and
a rubbing portion disposed on the surface of the light guide panel and extended in the second direction.

10. The fabricating method of the light guide panel as claimed in claim 9, wherein the rubbing portion is distributed on a same horizontal/vertical base line of the surface.

11. The fabricating method of the light guide panel as claimed in claim 9, wherein the rubbing portion is distributed on different horizontal/vertical base lines of the surface.

12. The fabricating method of the light guide panel as claimed in claim 9, wherein the included angle is 90±10 degrees.

13. The fabricating method of the light guide panel as claimed in claim 9, wherein the surface comprises a light incident surface, a light emitting surface or a reflective surface of the light guide panel.

14. The fabricating method of the light guide panel as claimed in claim 9, wherein the cutting section is coaxially arranged along the extending direction of the rotating axis.

15. The fabricating method of the light guide panel as claimed in claim 9, wherein the cutting section is spirally arranged along the extending direction of the rotating axis.

16. The fabricating method of the light guide panel as claimed in claim 9, wherein the base and the cutting section are integrally formed or are assembled with each other.

17. The fabricating method of the light guide panel as claimed in claim 9, wherein the microstructures are protruded from the cutting section, and the shape of the microstructures is selected from a semicircular shape, a V shape, an R-shaped groove or a combination thereof, and the shape of the microstructures is complementary to the shape of the optical microlenses of the optical element array.

18. The fabricating method of the light guide panel as claimed in claim 9, wherein the microstructures are recessed from the cutting section, and the shape of the microstructures is selected from a semicircular shape, a V shape, an R-shaped groove or a combination thereof, and the shape of the microstructures is complementary to the shape of the optical microlenses of the optical element array.

19. The fabricating method of the light guide panel as claimed in claim 9, wherein the microstructures are in the same size or in different sizes from each other.
